(19) United States
(12) Patent Application Publication
(10) Pub. No.: US 2012/0205055 A1
(43) Pub. Date: Aug. 16, 2012

(54) REFLECTOR SYSTEM FOR A WINDOW BLIND

(76) Inventor: TODD UNDERWOOD, Fairhope, AL (US)

(21) Appl. No.: 13/024,326

(22) Filed: Feb. 10, 2011

(51) Int. Cl. E06B 9/386; E06B 9/36; E06B 9/24

(52) U.S. Cl. 160/166.1; 160/236

(57) ABSTRACT

A reflector system for a window blind has a plurality of adjustable slats. The window blind is mounted on the inside of a window in a building. The reflector system comprises a plurality of reflective sheets. A mechanism is for affixing each reflective sheet onto one surface of a slat. When the slats are adjusted to a proper 30-60 degrees angle with the reflective sheets facing the window, the reflective sheets will reflect solar rays having radiant heat back out through the window to help cool the building in a 20 degrees differential temperature.

### CROSS-REFERENCE TO RELATED APPLICATION

This application claims the benefit of Provisional Patent Application No. 61/302,690, filed on Feb. 9, 2010, in the United States Patent & Trademark Office, the disclosure of which is incorporated herein by reference.

### BACKGROUND OF THE INVENTION

1. Field of the Invention

The present invention relates to a device for blocking sunlight, and more particularly, a reflector system for a window blind.

The present invention is configured to reflect radiant energy from natural sunlight before it becomes heat on an absorbing surface, preventing buildings from becoming overheated. The reflector system can be applied to Venetian blinds or vertical blinds of virtually any type of material. The present invention can effectively reflect up to ninety seven (97%) percent of the sun's energy, keeping buildings approximately twenty degrees cooler than the outside temperature. It is ideal for use in homes, offices, and other business buildings, particularly those located in highly sun-saturated areas.

2. Description of the Prior Art

Outdoor heat can easily penetrate windows and cause building temperatures to increase drastically. This may prompt consumers to turn air conditioners up to high levels, which can be costly and energy inefficient. Rooms that do not attract sunlight may become extremely cold while air conditioners are running. Rooms with excessive sun heat, however, may stay warm despite the operation of the air conditioners. Traditional window blinds that are used to block out sunlight and heat may be ineffective, allowing heat to radiate through the window blind slats. An effective solution is necessary.

Numerous innovations for reflecting structures have been provided in the prior art that will be described. Even though these innovations may be suitable for the specific individual purposes to which they address, however, they differ from the present invention.

A FIRST EXAMPLE, U.S. Pat. No. 4,645,704, Issued on Feb. 24, 1987, to Hellwig teaches a reflecting flexible textile web comprising a textile support metal coated on at least one side and in the form of a woven fabric, knitted fabric, non-woven fabric or thread ply sewn fabric, the threads or fibers of which are coated with possibly flame-retarding modified transparent plastic, in which high reflectivity is achieved for infrared radiation but at the same time translucence or light in the visible region in that the metal coating takes place substantially only in the region of the intersections of the threads or fibers while the regions of the textile support disposed between the intersections are substantially free from metal coating and thus permeable to light. Furthermore, a method for making said textile web is proposed in which the textile support is firstly coated by immersion impregnation with a highly viscous plastic dispersion and metal is transferred in the transfer method from a metal-coated foil under elevated temperature and elevated temperature selectively to the raised regions of the plastic-coated textile support. The textile web can be used in particular for making sun roller blinds and insulating roller blinds.

A SECOND EXAMPLE, U.S. Pat. No. 5,176,774, issued on May 5, 1993, to Laniado et al. teaches a multilayer plastic sheet of self-rollable material comprising at least two layers of material joined to one another at states of different relative stretch and capable of alternating between a relaxed and a tensioned state and of inherently assuming a rolled-up configuration in the relaxed state as a result of the different states of stretch of the respective layers and to retain the inherent property of spontaneous rolling up even after prolonged exposure to sunlight and heat. The invention also provides a process for preparing a rollable sheet containing at least one layer of laminatable plastic material, the sheet being capable of alternating between a relaxed and a tensioned state and of inherently assuming a rolled up configuration in the relaxed state and retaining the inherent property of spontaneous rolling up even after prolonged exposure to sunlight and heat, the process comprising heating and stretching a first sheet of plastic material and laminating the first sheet of prestretched plastic material to a second sheet of non-stretched material, to form a self-rollable composite sheet.

A THIRD EXAMPLE, U.S. Pat. No. 5,269,360, issued on Dec. 14, 1993, to Chen teaches a pleated blinds for car which may be split into two pieces and secured onto respective sides of car window by virtue of double-sizing tape or fastening band for the user to hold the pull lug of left-handed and right-handed pleated blinds, separate the fastening band at the short side from the fastening band on the car window, pull them toward the center position of windshield, then fasten together the fastening bands on respective pull lugs to accomplish a full size sun shading. When not in use, pull the fastening band on each pull lug toward respective sides of windshield and attach thereto, take up the pull lugs sidewise and fasten together the fastening band on each pull lug and the fastening band at respective sides of front screen to accomplish storage of pleated blinds in position. Each piece of pleated blinds comprises a pleated shade, an L-shaped fastening piece, a pull lug, a fastening band, a rail wire and an intermediate fastening piece.

A FOURTH EXAMPLE, U.S. Patent Office Publication No. 2008/0092456, Published on Apr. 24, 2008, to Millett et al. teaches an energy efficient, thermochromic device that may be used to allow sunlight or solar radiation into a building or structure when sunlight is absent or at high sun angles and substantially blocks solar radiation when sunlight is directly on the window.

A FIFTH EXAMPLE, U.S. Patent Office Publication No. 2009/0044919, Published on Feb. 19, 2009, to Pitman teaches a window blind that includes at least one blind element having a front surface and a back surface. Either the front surface or the back surface of each element can include a reflective material having a reflectivity of at least about 50%. Also disclosed is a method of controlling heat exchange through a transparent or translucent material that includes attaching a reflective window blind to an interior wall of a shelter. The window blind being oriented, such that the one or more blind elements can be manipulated to obscure a window in the interior wall. The window blind elements can then be adjusted such that the reflective material faces an interior of the shelter or an exterior of the shelter. The blind elements can be opaque, transparent or translucent.

It is apparent now that numerous innovations for reflecting structures have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a reflector system for a window blind that avoids the disadvantages of the prior art.

ANOTHER OBJECT of the present invention is to provide a reflector system for a window blind that is simple and inexpensive to manufacture.

STILL ANOTHER OBJECT of the present invention is to provide a reflector system for a window blind that is simple to use.

BRIEFLY STATED, STILL YET ANOTHER OBJECT of the present invention is to provide a reflector system for a window blind that has a plurality of adjustable slats. The window blind is mounted on the inside of a window in a building. The reflector system comprises a plurality of reflective sheets. A mechanism is for affixing each reflective sheet onto one surface of a slat. When the slats are adjusted to a proper angle with the reflective sheets facing the window, the reflective sheets will reflect solar rays having radiant heat back out through the window to help cool the interior of the building (e.g. the temperature of the interior building is 20 degrees lower than the outside ambient temperature). The outside temperature can be hot at 92 degrees and the interior temperature is only 72 degrees if we use aluminum foil as the reflective sheet.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is an external elevational view showing the present invention on a Venetian blind within a window of a portion of a building;

FIG. 2 is a rear perspective view of a portion of the Venetian blind with the present invention affixed to the slats;

FIG. 3 is an enlarged perspective view of the dotted area indicated by arrow 3 in FIG. 2;

FIG. 4 is an exploded perspective view showing the two components of the present invention ready to be installed on a slat; and

FIG. 5 is an internal perspective view of a vertical blind within a window of a building that contains the present invention.

### REFERENCE NUMERALS UTILIZED IN THE DRAWING

110 reflector system
112 window blind
114 slat of window blind 112
116 window in building 118
118 building
120 reflective sheet of reflector system 110
122 affixing mechanism of reflector system 110
124 one surface of slat 14
126 aluminum foil for reflective sheet 120
128 adhesive material for affixing mechanism 122
130 Venetian blind for window blind 112
132 vertical blind for window blind 112

### DETAILED DESCRIPTION OF THE PREFERRED EMBODIMENT

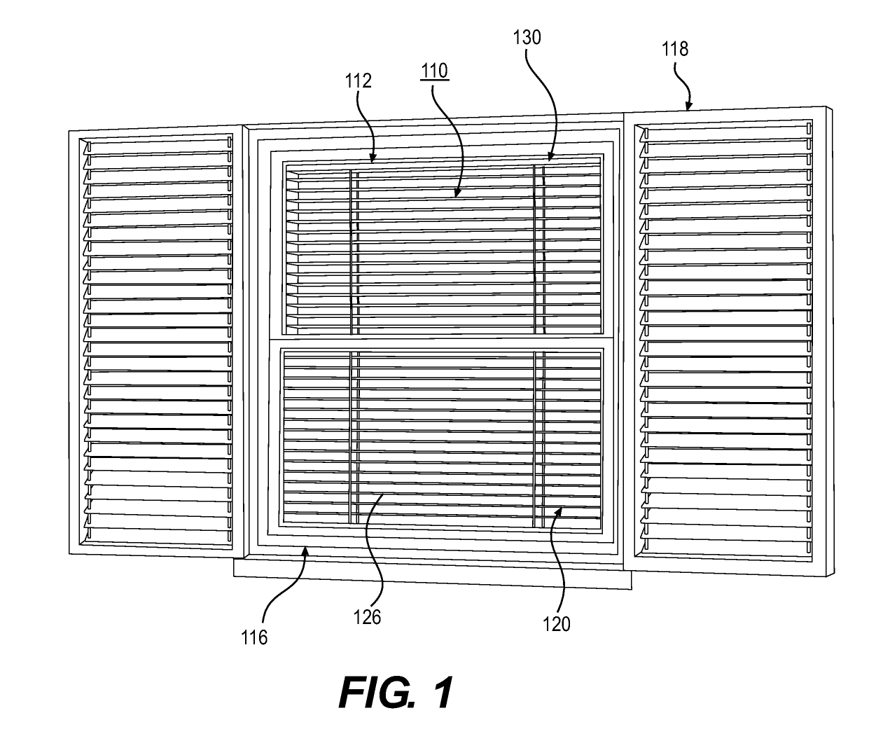

Referring now to the figures, in which like numerals indicate like parts, and particularly to FIGS. 1 through 5, and as such, will be discussed with reference thereto.

As shown in FIG. 1, a reflector system 110 for a window blind 112 that has a plurality of adjustable slats 114. The window blind 112 is mounted on the inside of a window 116 in a building 118.

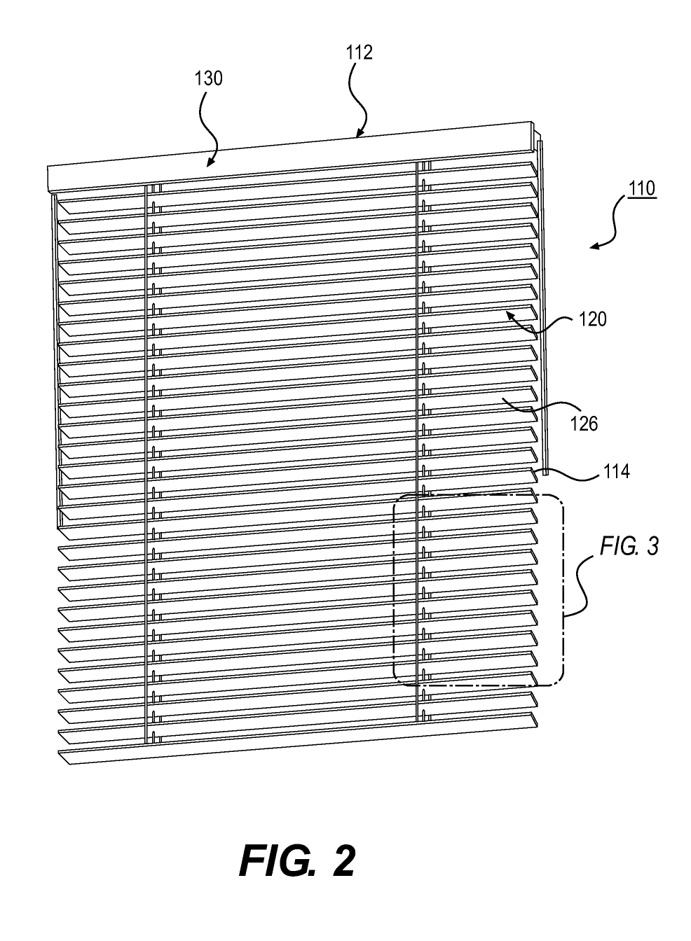

As shown in FIG. 2, the reflector system 110 comprises a plurality of reflective sheets 120. A mechanism 122 is for affixing each reflective sheet 120 onto one surface 124 of a slat 114. When the slats 114 are adjusted to a proper 30-60 degrees angle with the reflective sheets 120 facing the window 116, the reflective sheets 120 will reflect solar rays having radiant heat back out through the window 116 to help cool the building 118.

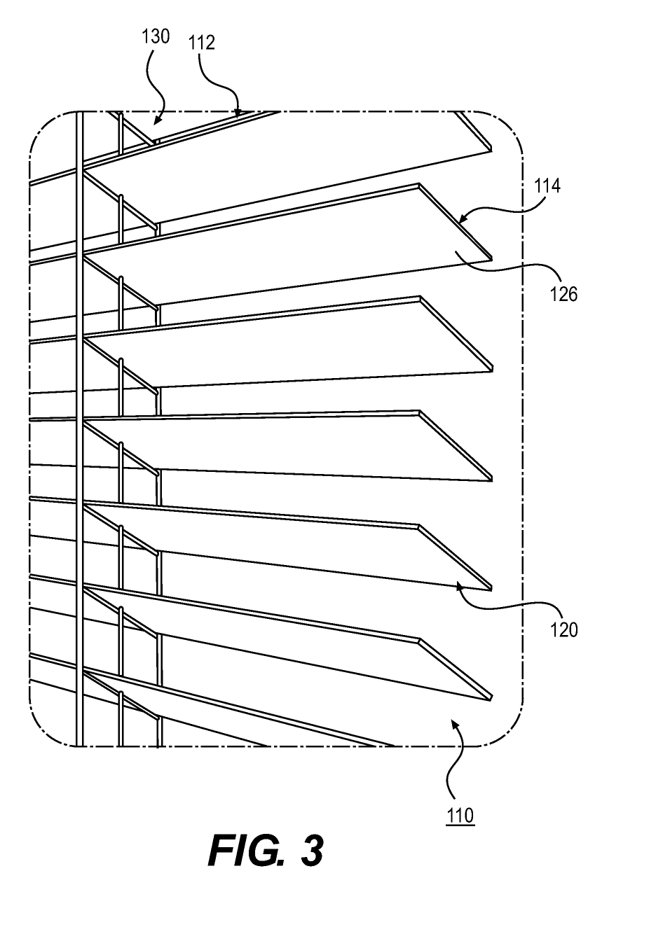

As shown in FIG. 3, each reflective sheet 120 is approximately one millimeter thick. All of the reflective sheets 120 will reflect up to ninety seven (97%) percent of the solar rays radiant heat. Each slat 114 of the window blind 112 can be fabricated out of a material selected from the group consisting of plastic, metal and wood. The window blind 112, as shown in FIGS. 1 through 3, is a Venetian blind 130.

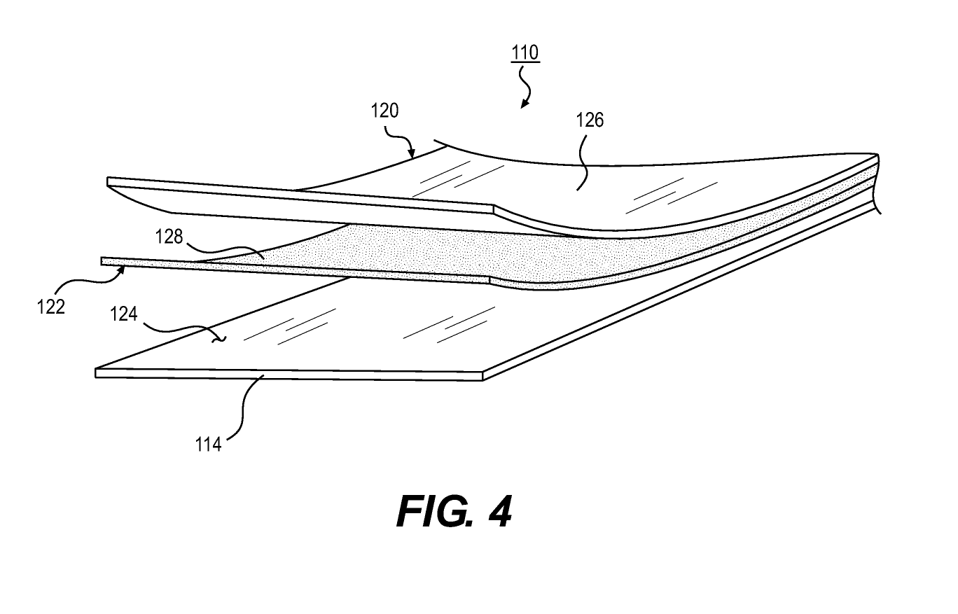

As best seen in FIG. 4, each reflective sheet 120 is comprised out of aluminum foil 126. A low-emissive material such as aluminum foil 126 has an emissivity value of 0.03 and a reflectance value of 0.97, meaning the foil reflects 97% of radiant energy and emits only 3%. The affixing mechanism 122 is comprised out of an adhesive material 128. The adhesive material 128 is a quick stick acrylic adhesive double coat tape with polyethylene terephtalate (polyester) PET Film Liner. The double coated tape has exceptional adhesion properties and bonds well to high and low surface energy plastics surface. In addition, the adhesive material tape can be in a roll. The temperature of the interior building is reduced 20 degrees lower than the outside ambient temperature. The outside temperature can be hot at 92 degrees and the interior temperature is only 72 degrees if we use aluminum foil as the reflective sheet. The reflective aluminum foil saves the electrical energy of running air conditioner to cool the building down during the hot temperature.

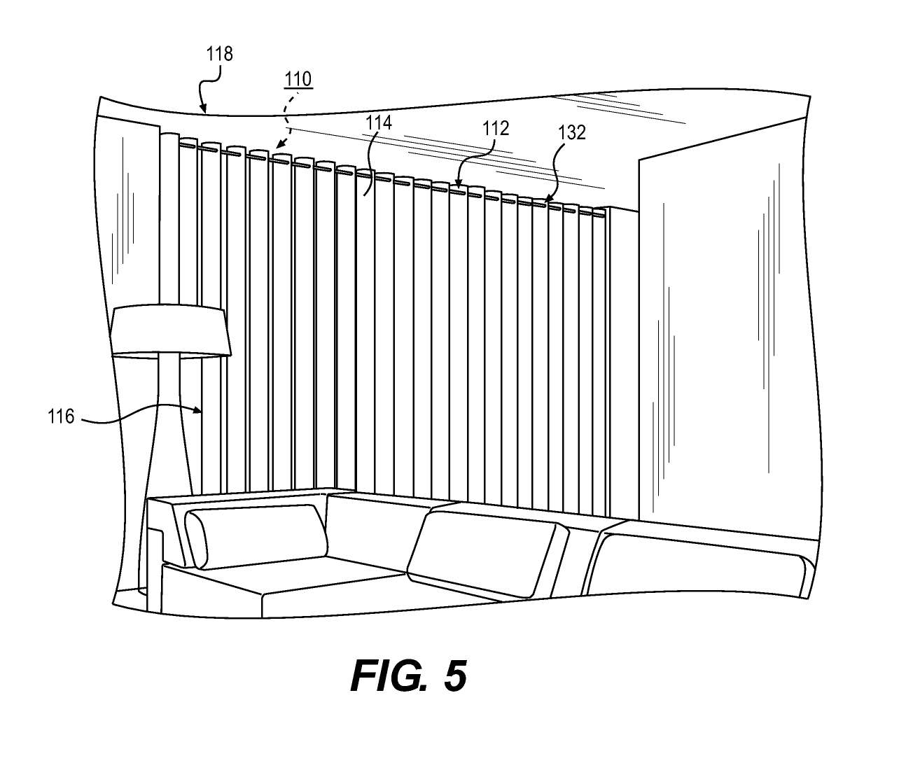

As shown in the FIG. 5, the window blind 112 is a vertical blind 132.

In review, the reflector system 110 blocks natural outdoor heat and sunlight to keep the building 118 cool. The present invention is used on slats 114 of a window blind 112 that can be made of plastic, metal, wood, or other suitable materials. Each slat 114 of the window blind 112 will include a reflective sheet 120 being an aluminum foil 126 approximately one millimeter thick, located on the outward-facing side of each slat 114. The aluminum foil 126 is applied to one surface 124 of the slat 114 and may not wrap around the edges or sides. The surface 124 can have tiny grooves to increase the adhesion between two layers. The tiny grooves can be in 3-tiny slot form, matrix form, honeycomb form, square form, rectangular form or geometric form. An affixing mechanism 122 is an adhesive material 128 that is used to securely affix the aluminum foil 126 to the slats 114. When in use, the slats 114 of the window blind 112 is adjusted so that the aluminum foil 126 is facing the outside, to reflect sunlight and prevent heat from entering through the window 116. The window blind 112 can be a Venetian blind 130 or a vertical blind 132. The exact specifications may vary.

It will be understood that each of the elements described above, or two or more together, may also find a useful application in other types of constructions differing from the types described above.

While the invention has been illustrated and described as embodiments of a reflector system for a window blind, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A reflector system for a window blind, which is mounted on the inside of a window in a building, the reflector system comprises:
a) a plurality of corresponding slats which surface has tiny grooves to increase the adhesion;
b) a plurality of corresponding reflective sheets; and
c) means for affixing each reflective sheet onto one tiny grooved surface of the corresponding slat, whereby when the slats are adjusted to a proper 30-60 degrees angle with the reflective sheets facing the window, the reflective sheets will reflect solar rays having radiant heat back out through the window to help cool the building in a twenty (20) degrees lower comparing to the outside ambient temperature.

2. The reflector system as recited in claim 1, wherein each reflective sheet is approximately one millimeter thick.

3. The reflector system as recited in claim 1, wherein all of the reflective sheets will reflect up to ninety seven (97%) percent of the solar rays radiant heat.

4. The reflector system as recited in claim 1, wherein each reflective sheet is comprised out of aluminum foil.

5. The reflector system as recited in claim 1, wherein the affixing means is comprised out of an adhesive material such as a quick stick acrylic adhesive double coat tape with polyethylene terephtalate (polyester) PET Film Liner.

6. The reflector system as recited in claim 1, wherein each slat of the window blind is fabricated out of a material selected from the group consisting of plastic, metal and wood.

7. The reflector system as recited in claim 1, wherein the window blind is a Venetian blind.

8. The reflector system as recited in claim 1, wherein the window blind is a vertical blind.

9. The reflector system as recited in claim 1, wherein the tiny grooves can be in 3-tiny slot form, matrix form, honeycomb form, square form, rectangular form or geometric form.
